(19) United States
(12) Patent Application Publication
(10) Pub. No.: US 2014/0001397 A1
(43) Pub. Date: Jan. 2, 2014

(54) METAL-POLYMER COMPLEX FILM FOR INDUCTOR AND METHOD FOR MANUFACTURING THE SAME

(71) Applicant: SAMSUNG ELECTRO-MECHANICS CO., LTD., Suwon-si (KR)

(72) Inventors: Moon Soo PARK, Gyeonggi-do (KR); Ic Seob KIM, Gyeonggi-do (KR); Hwan Soo LEE, Gyeonggi-do (KR); Dong Hyeok CHOI, Gyeonggi-do (KR); Hye Yeon CHA, Gyeonggi-do (KR)

(21) Appl. No.: 13/930,946

(22) Filed: Jun. 28, 2013

(30) Foreign Application Priority Data
Jun. 28, 2012 (KR) 10-2012-0070049

(51) Int. Cl. H01F 1/01; F27D 7/06; H01F 41/14

(52) U.S. Cl. CPC H01F 1/01; H01F 41/14; F27D 7/06
USPC 252/62.54; 29/602.1; 432/23

(57) ABSTRACT

Disclosed herein are a metal-polymer complex film for an inductor and a method for manufacturing an inductor, the inductor being manufactured by using the metal-polymer complex film for an inductor, including: a metal powder; and an amorphous epoxy resin, wherein the metal-polymer complex film is made in a film type by using a mixture where a weight ratio of the metal powder is 75˜98 wt %, so that a plurality of inductors can be simultaneously manufactured to thereby improve production efficiency and characteristic values of the inductor can be also improved.

### CROSS REFERENCE(S) TO RELATED APPLICATIONS

This application claims the benefit under 35 U.S.C. Section 119 of Korean Patent Application Serial No. 10-2012-0070049, entitled “Metal-Polymer Complex Film for Inductor and Method for Manufacturing the Same” filed on Jun. 28, 2012, which is hereby incorporated by reference in its entirety into this application.

### BACKGROUND OF THE INVENTION

1. Technical Field

The present invention relates to a metal-polymer complex film for an inductor and a method for manufacturing the same.

2. Description of the Related Art

Devices have been increasingly demanded to have a smaller size and a slimmer thickness with the development of IT technology, and for this reason, various elements included in the devices have been increasingly developed to have a smaller size and a smaller thickness.

An inductor is generally manufactured by coating a magnetic material on a substrate on which coils are formed.

Meanwhile, Patent Document 1 and Patent Document 2 disclose an inductor of which a metal-polymer complex is realized by using a magnetic material.

According to Patent Document 1 and Patent Document 2, a magnetic substance is formed by using a metal-polymer complex in a type of powder or clay having greater fluidity. However, a mold and a jig are separately needed for achieving this, which are disadvantageous in mass-producing small chips.

### RELATED ART DOCUMENTS

### Patent Documents

(Patent Document 1) Korean Patent Laid-Open Publication No. 2010-0113029

(Patent Document 2) Japanese Patent Laid-Open Publication No. 2010-034102

### SUMMARY OF THE INVENTION

An object of the present invention is to provide a metal-polymer complex film for an inductor in a film type, capable of forming a magnetic material at the time of manufacturing the inductor.

Further, another object of the present invention is to provide a method for manufacturing an inductor by using the metal-polymer complex film for an inductor.

According to an exemplary embodiment of the present invention, there is provided a metal-polymer complex film for an inductor, including: a metal powder; and an amorphous epoxy resin, wherein the metal-polymer complex film is made in a film type by using a mixture where a weight ratio of the metal powder is 75˜98 wt %.

The metal powder may include first metal particles and second metal particles having different diameters.

The first metal particle may have a diameter of 20˜100 μm, and the second metal particle may have a diameter of less than 10 μm.

The first metal particles and the second metal particles may be included in the metal powder at a weight ratio of 1˜4:1.

The amorphous epoxy resin may be a novolac based epoxy resin or a rubber based polymer epoxy resin having a molecular weight of 15000 or higher.

The metal-polymer complex film for an inductor may further include a rubber based toughening agent.

Here, a content of the rubber based toughening agent may be 1˜30 PHR of the amorphous epoxy resin.

According to another exemplary embodiment of the present invention, there is provided a method for manufacturing an inductor, the method including: (A) providing a coil part made of a conductive pattern on one surface or both surfaces of a substrate, to form a coil layer; (B) laminating the metal-polymer complex films for an inductor according to claim 1 on upper and lower surfaces of the coil layer; and (C) pressing and curing the coil layer and the metal-polymer complex films for an inductor.

The method may further include, between Stage (A) and Stage (B), forming a core hole penetrating the coil layer.

Here, Stage (C) may be performed under the conditions of a temperature of 170˜200° C., a surface pressure of 0.05˜20 kgf, and a vacuum degree of 0.1 torr or lower.

The metal powder may include first metal particles and second metal particles having different diameters.

The first metal particle may have a diameter of 20˜100 μm, and the second metal particle may have a diameter of less than 10 μm.

The first metal particles and the second metal particles may be included in the metal powder at a weight ratio of 1˜4:1.

The amorphous epoxy resin may be a novolac based epoxy resin or a rubber based polymer epoxy resin having a molecular weight of 15000 or higher.

The metal-polymer complex film for an inductor may include a rubber based toughening agent.

Here, a content of the rubber based toughening agent may be 1˜30 PHR of the amorphous epoxy resin.

According to still another exemplary embodiment of the present invention, there is provided a method for manufacturing an inductor, the method including: (a) providing a plurality of coil parts made of conductive patterns on one surface or both surfaces of a substrate, to form a coil layer; (b) laminating the metal-polymer complex films for an inductor according to claim 1 on upper and lower surfaces of the coil layer; (c) pressing and curing the coil layer and the metal-polymer complex films for an inductor; (d) dicing the resultant structure subjected to Stage (c) to thereby separate the plurality of coil parts into each single coil part; and (e) forming external electrodes on the resultant structure subjected to Stage (d).

The method may further include, between Stage (a) and Stage (b), performing a punching process to provide core holes penetrating the coil layer, for the plurality of coil parts, respectively.

Here, Stage (c) may be performed under the conditions of a temperature of 170˜200° C., a surface pressure of 0.05˜20 kgf, and a vacuum degree of 0.1 torr or lower.

### BRIEF DESCRIPTION OF THE DRAWINGS

FIG. 1 is a cross-sectional view schematically showing an inductor manufactured by a method for manufacturing an inductor according to an exemplary embodiment of the present invention;

FIGS. 2A to 2D are views schematically showing a method for manufacturing an inductor according to the exemplary embodiment of the present invention, wherein,

FIG. 2A shows a coil layer,

FIG. 2B shows a procedure of laminating a plurality of metal-polymer complex films on upper and lower surfaces of the coil layer,

FIG. 2C shows a procedure of pressing/curing a laminate where the coil layer and the metal-polymer complex films are laminated, and

FIG. 2D shows a procedure of forming external electrodes after the pressing/curing are finished, thereby completing the inductor;

FIG. 3 is a flow chart schematically showing a method for manufacturing an inductor according to another exemplary embodiment of the present invention;

FIGS. 4A to 4E are views schematically showing a method for manufacturing an inductor according to another exemplary embodiment of the present invention, wherein,

FIG. 4A shows a state where a plurality of coil parts are formed on one substrate,

FIG. 4B shows a state where core holes are formed in the substrate,

FIG. 4C shows a state where metal-polymer complex films are laminated on upper and lower surfaces of a coil layer,

FIG. 4D shows a plurality of dicing lines, and

FIG. 4E shows a plurality of inductors;

FIG. 5 is a view schematically showing a metal-polymer complex film for an inductor according to the exemplary embodiment of the present invention; and

FIG. 6 is a view schematically showing a comparative example of FIG. 5.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Identical reference numerals denote identical elements, throughout the description

Terms used in the present specification are for explaining the exemplary embodiments rather than limiting the present invention. In the specification, a singular type may also be used as a plural type unless stated specifically. The word “comprise” and variations such as “comprises” or “comprising,” will be understood to imply the inclusion of stated constituents, steps, operations and/or elements but not the exclusion of any other constituents, steps, operations and/or elements.

Hereinafter, constitutions and operating effects of the present invention will be described in more detail with reference to the accompanying drawings.

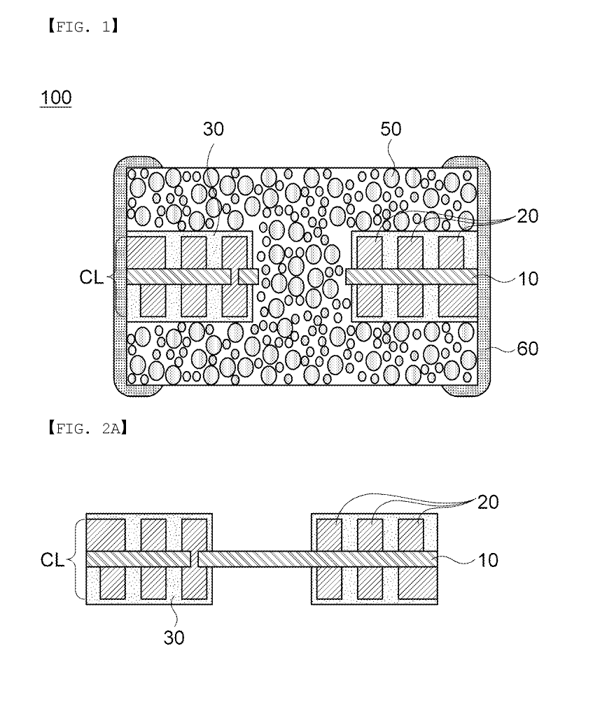

FIG. 1 is a cross-sectional view schematically showing an inductor manufactured by a method for manufacturing an inductor according to an exemplary embodiment of the present invention.

Referring to FIG. 1, an inductor 100 manufactured by the method for manufacturing an inductor according to an exemplary embodiment of the present invention may include a substrate 10, a conductive pattern, a magnetic material 50, and external electrodes 60.

Here, the magnetic material 50 as a metal-polymer complex is formed by not using a powder type or fluid type metal-polymer complex according to the related art but using a film type metal-polymer complex, so that the inductor 100 may be manufactured even without a mold or a jig.

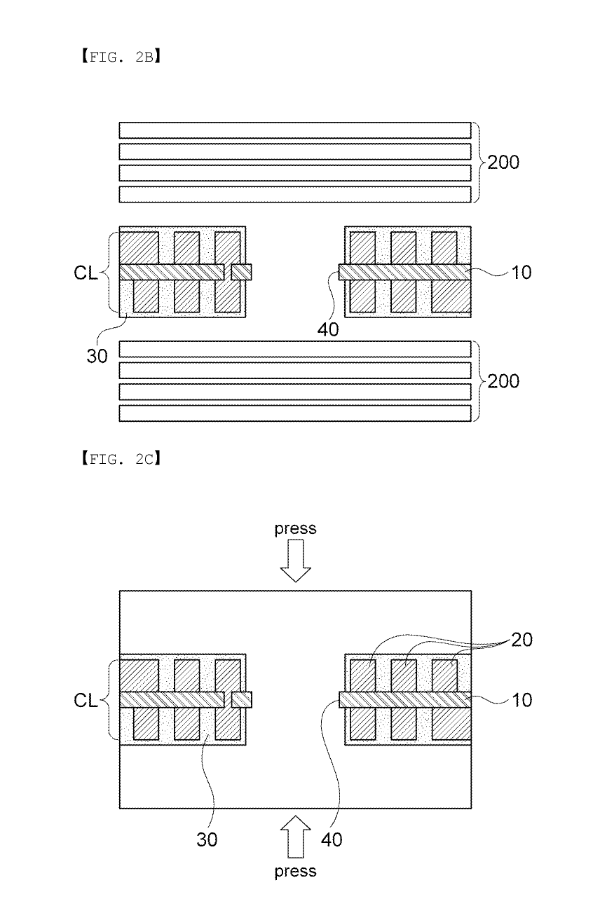

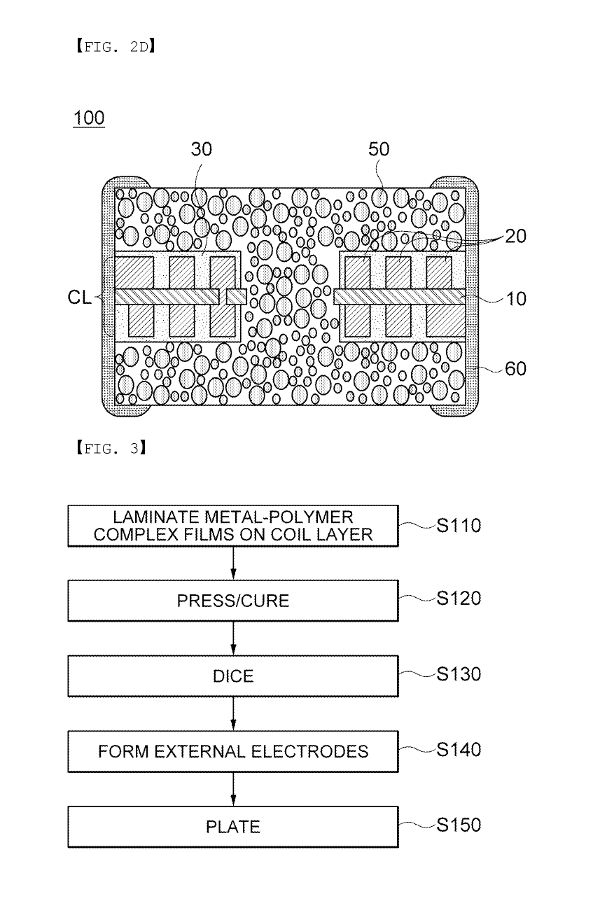

FIGS. 2A to 2D are views schematically showing a method for manufacturing an inductor according to the exemplary embodiment of the present invention. FIG. 2A shows a coil layer CL; FIG. 2B shows a procedure of laminating a plurality of metal-polymer complex films 200 on upper and lower surfaces of the coil layer CL; FIG. 2C shows a procedure of pressing/curing a laminate where the coil layer CL and the metal-polymer complex films are laminated; and FIG. 2D shows a procedure of forming external electrodes 60 after the pressing/curing are finished, thereby completing the inductor 100.

Referring to FIG. 2A, first, a conductive pattern 20 is provided on both surfaces of a substrate 10 to thereby form a coil part, and an insulator part 30 is formed on a surface of the conductive pattern 20.

Referring to FIG. 2B, a plurality of metal-polymer complex films 200 may be laminated on upper and lower surfaces of a coil layer CL where a core hole 40 is formed in the substrate 10.

Referring to FIG. 2C, a laminate where the coil layer CL and the metal-polymer complex films for an inductor 100 are laminated may be pressed/cured.

Here, although not shown in FIG. 2C, the laminate may be pressed/cured by using an apparatus such as V-press or the like, while predetermined conditions of temperature, surface pressure, and vacuum degree are satisfied.

FIG. 2D shows the inductor 100 completed by forming external electrodes 60 after the pressing/curing are finished.

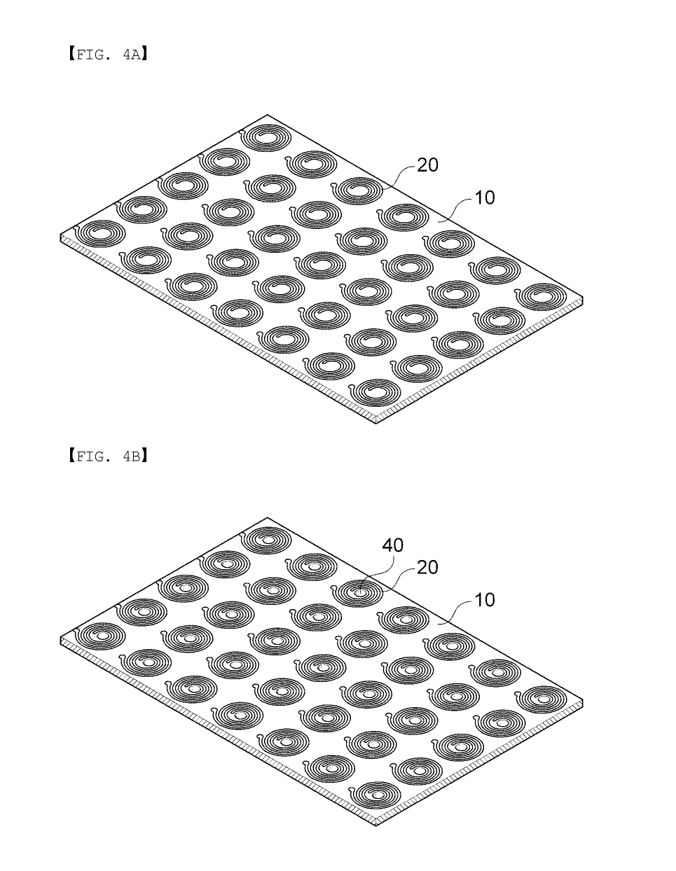

FIG. 3 is a flow chart schematically showing a method for manufacturing an inductor according to another exemplary embodiment of the present invention.

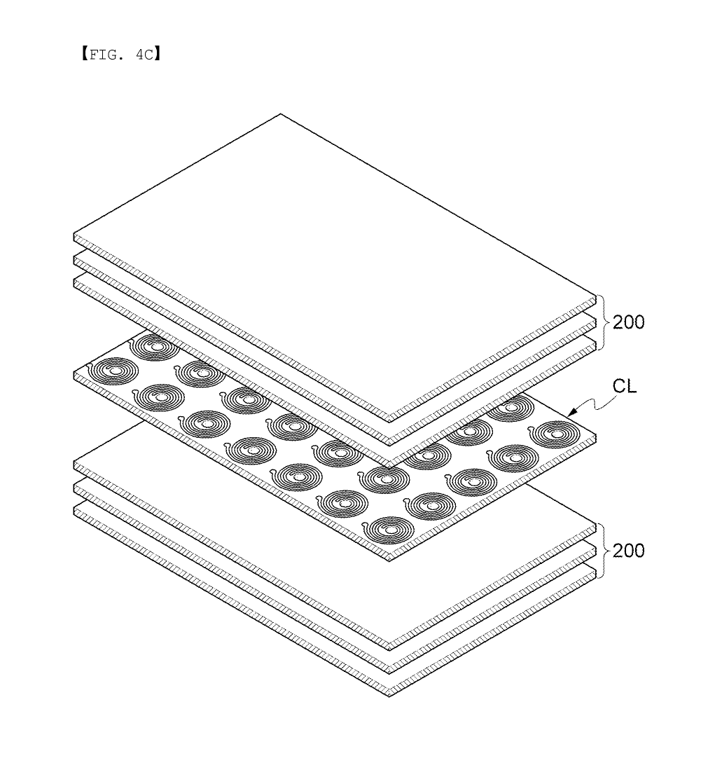

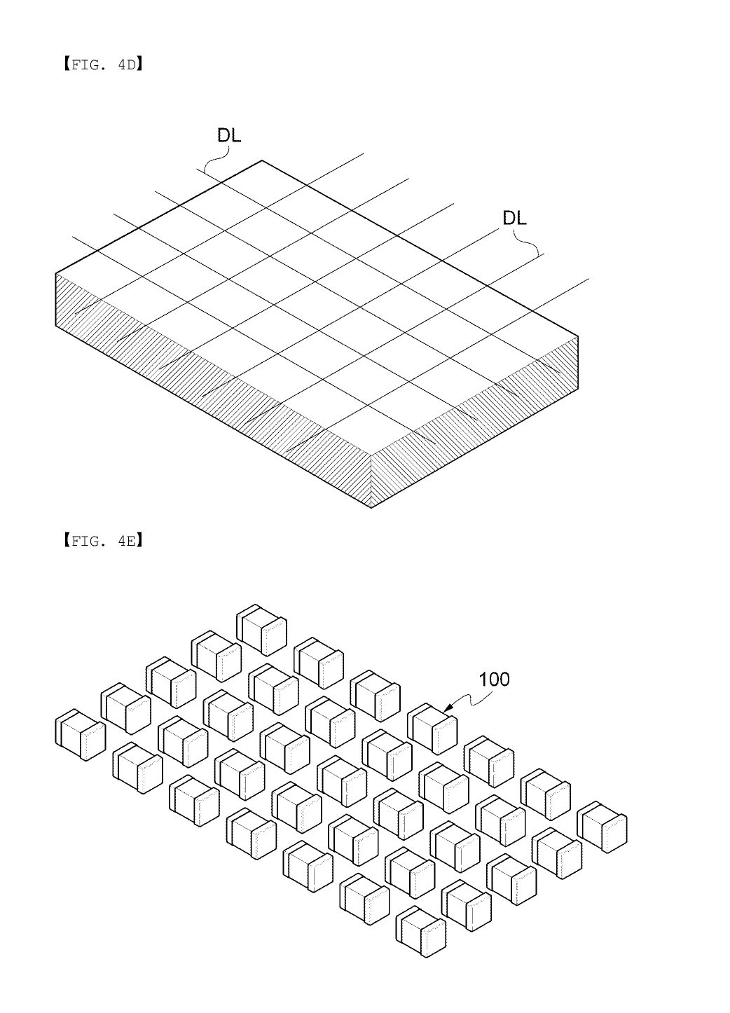

In addition, FIGS. 4A to 4E are views schematically showing a method for manufacturing an inductor according to another exemplary embodiment of the present invention. FIG. 4A shows a state where a plurality of coil parts are formed on one substrate 10; FIG. 4B shows a state where core holes 40 are formed in the substrate 10; FIG. 4C shows a state where metal-polymer complex films 200 are laminated on upper and lower surfaces of a coil layer CL; FIG. 4D shows a plurality of dicing lines DL; and FIG. 4E shows a plurality of inductors 100.

Referring to FIGS. 3 and 4, a plurality of coil parts may be formed on one substrate 10, as shown in FIG. 4A.

Here, as shown in FIG. 4B, a punching process may be performed so that the core holes 40 are provided in a middle region of each of the coil parts at which cores are to be formed.

Then, as shown in FIG. 4C, the metal-polymer complex films 200 for an inductor are laminated on upper and lower surfaces of the coil layer CL (S110).

Then, a laminate of the coil layer CL and the metal-polymer complex films 200 are pressed/cured (S120). Here, the laminate may be pressed/cured by using an apparatus such as V-press or the like while predetermined conditions of temperature, surface pressure, and vacuum degree are satisfied.

Then, after the pressing/curing are finished, a dicing process for separating a plurality of coil parts from one another is performed (S130). Here, as shown in FIG. 4D, after the dicing process is performed by using a plurality of dicing lines (DL) parallel with a horizontal axis and a plurality of dicing lines (DL) parallel with a vertical axis, the external electrodes 60 are formed (S140). Hence, as shown in FIG. 4E, a plurality of inductors 100 can be promptly manufactured.

Here, plating layers may be further provided on surfaces of the external electrodes 60 in order to improve soldering reliability in a procedure where the inductor 100 is mounted on a PCB or the like (S150).

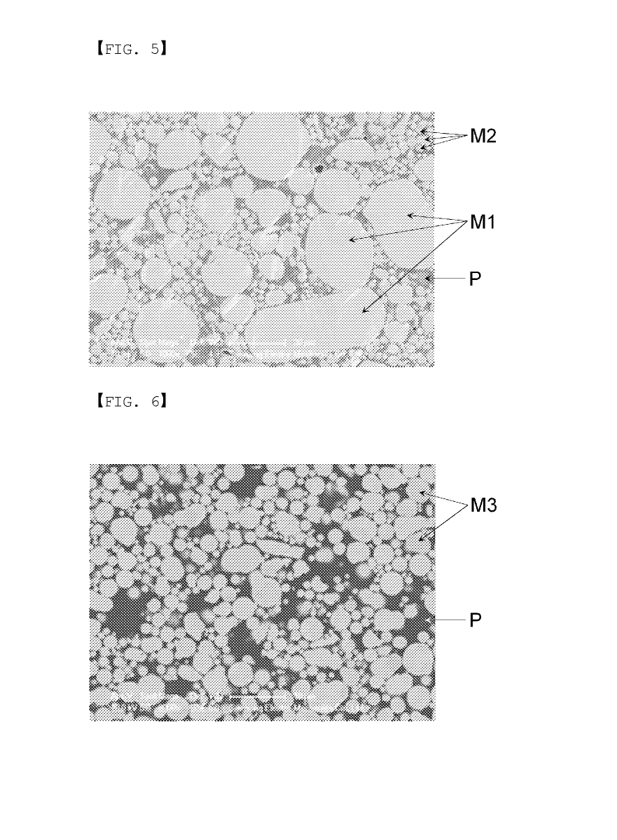

FIG. 5 is a view schematically showing a metal-polymer complex film 200 according to the exemplary embodiment of the present invention.

Referring to FIG. 5, the metal-polymer complex film 200 according to the exemplary embodiment of the present invention may include a metal powder including metal particles M1 and M2 and a polymer P.

Here, an amorphous epoxy resin may be preferably used as a polymer in order to form the metal-polymer complex film 200 for an inductor according to the exemplary embodiment of the present invention.

An example of the polymer that is widely used in the related art may include a crystalline biphenyl type epoxy. However, the use of this crystalline epoxy makes it difficult to realize the metal-polymer complex into a film type, and also make it difficult to perform processes when the crystalline epoxy is utilized during the manufacture of the inductor 100.

Therefore, in the metal-polymer complex film 200 for an inductor according to the exemplary embodiment of the present invention, an amorphous epoxy is used as the polymer, and particularly, preferable are a novolac based epoxy resin, or a rubber based polymer epoxy resin having a molecular weight of 15000.

Meanwhile, various kinds of metal powder having magnetic property may be used as a metal powder. Here, in a mixture of a metal powder and an amorphous epoxy resin, the weight ratio of the metal powder is preferably in the range of 75˜98 wt %.

If the metal powder is included in a content of below 75 wt %, the content of the resin, which is a non-magnetic material, is relatively increased, which may prevent the flow of magnetic flux for realizing inductor characteristics. When the metal powder was included in a content of 75 wt % or less, other conditions being equal, the inductance value was measured to be lower by about 30% as compared with the design value.

If the metal powder is included in a content of above 98 wt %, the yield in the procedure of forming the metal-polymer complex film for an inductor may be remarkably decreased.

In addition, when the metal powder includes only particles having similar particle diameters, uniform distribution stability thereof can not be obtained in the metal-polymer complex film 200, and thus, the filling degree thereof may be decreased after a lamination process.

Therefore, the metal powder is preferably composed of first metal particle M1 and second metal particle M2, which have different particle diameters. More preferably, the first metal particle M1 may have a diameter of 20˜100 μm and the second metal particle M2 may have a diameter of below 10 μm.

In addition, the content ratio of the first metal particles M1 to the second metal particles M2 is preferably 1˜4:1.

If the content of the first metal particles is less than the content of the second metal particles or more 4 times the content of the second metal particles, the filing ratio between pores and the metal powder is not suitable, and thus, it may be difficult to include the largest amount of metal powder in a unit volume during a filling procedure.

This shortage of filing density may bring about a decrease in magnetization density, which is a factor for preventing realization of inductance characteristics.

FIG. 6 is a view schematically showing a comparative example of FIG. 5. Referring to FIGS. 5 and 6, the filling degree of metal powder is secured at 70˜80% or higher when the first metal particles M1 and the second metal particles M2 are mixed at an optimum ratio, as shown in FIG. 5. Whereas, otherwise, the filling degree of metal powder is decreased to 60% or less as shown in FIG. 6, and thus, magnetic characteristics of the inductor 100 may be relatively deteriorated.

Meanwhile, in forming a magnetic material 50 by using the metal-polymer complex film 200 for an inductor, mechanical strength is increased to further improve processability.

For achieving this, the metal-polymer complex film 200 for an inductor can be realized by further including a rubber based toughening agent therein.

Here, the content of the rubber based toughening agent is preferably about 1˜30 part per hundred resin (PHR) of an amorphous epoxy resin.

If the content of the rubber based toughening agent is less than 1 PHR, improvement in processability can not be achieved. If the content thereof is more than 30 PHR, mechanical properties of the inductor may be deteriorated after curing.

In manufacturing the inductor 100 by using the metal-polymer complex film 200 for an inductor realized as above, it is preferable to satisfy predetermined conditions of temperature, surface pressure, and vacuum degree.

If the curing temperature is too low, curing is not completely performed, which may cause reliability problems when processes are performed. If the curing temperature is too high, the resin may be deteriorated.

If the surface pressure is too low, all the core regions having a depth of several hundreds of micrometers are not filled. If the surface pressure is too high, the substrate on which the conductive pattern is formed may be deformed.

In addition, a predetermined vacuum degree is necessarily needed in order to remove residual solvent in the metal-polymer complex film for an inductor.

Therefore, the pressing/curing are preferably performed under the conditions of a temperature of 170˜200° C., a surface pressure of 0.05˜20 kgf, and a vacuum degree of 0.1 torr or lower.

As set forth above, according to the present invention, the inductor can be manufactured even without a mold and a jig, unlike the related art, and thus, a plurality of inductors are simultaneously manufactured, to thereby improve production efficiency significantly.

Further, the pressing/curing processes can be performed in conditions of lower temperature and pressure than the related art where the metal-polymer complex is used as a magnetic material, and thus, the reduction in magnetic characteristics of the metal-polymer complex can be minimized, to thereby further improve characteristic values of the inductor as compared with the related art.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A metal-polymer complex film for an inductor, comprising:
a metal powder; and
an amorphous epoxy resin,
wherein the metal-polymer complex film is made in a film type by using a mixture where a weight ratio of the metal powder is 75˜98 wt %.

2. The metal-polymer complex film for an inductor according to claim 1, wherein the metal powder includes first metal particles and second metal particles having different diameters.

3. The metal-polymer complex film for an inductor according to claim 2, wherein the first metal particle has a diameter of 20˜100 μm, and the second metal particle has a diameter of less than 10 μm.

4. The metal-polymer complex film for an inductor according to claim 3, wherein the first metal particles and the second metal particles are included in the metal powder at a weight ratio of 1˜4:1.

5. The metal-polymer complex film for an inductor according to claim 1, wherein the amorphous epoxy resin is a novolac based epoxy resin or a rubber based polymer epoxy resin having a molecular weight of 15000 or higher.

6. The metal-polymer complex film for an inductor according to claim 1, further comprising a rubber based toughening agent.

7. The metal-polymer complex film for an inductor according to claim 6, wherein a content of the rubber based toughening agent is 1˜30 PHR of the amorphous epoxy resin.

8. A method for manufacturing an inductor, the method comprising:
(A) providing a coil part made of a conductive pattern on one surface or both surfaces of a substrate, to form a coil layer;
(B) laminating the metal-polymer complex films for an inductor according to claim 1 on upper and lower surfaces of the coil layer; and
(C) pressing and curing the coil layer and the metal-polymer complex films for an inductor.

9. The method according to claim 8, further comprising, between Stage (A) and Stage (B), forming a core hole penetrating the coil layer.

10. The method according to claim 8, wherein Stage (C) is performed under the conditions of a temperature of 170˜200° C., a surface pressure of 0.05˜20 kgf, and a vacuum degree of 0.1 torr or lower.

11. The method according to claim 8, wherein the metal powder includes first metal particles and second metal particles having different diameters.

12. The method according to claim 11, wherein the first metal particle has a diameter of 20˜100 μm, and the second metal particle has a diameter of less than 10 μm.

13. The method according to claim 12, wherein the first metal particles and the second metal particles are included in the metal powder at a weight ratio of 1˜4:1.

14. The method according to claim 8, wherein the amorphous epoxy resin is a novolac based epoxy resin or a rubber based polymer epoxy resin having a molecular weight of 15000 or higher.

15. The method according to claim 8, wherein the metal-polymer complex film for an inductor includes a rubber based toughening agent.

16. The method according to claim 15, wherein a content of the rubber based toughening agent is 1˜30 PHR of the amorphous epoxy resin.

17. A method for manufacturing an inductor, the method comprising:
(a) providing a plurality of coil parts made of conductive patterns on one surface or both surfaces of a substrate, to form a coil layer;
(b) laminating the metal-polymer complex films for an inductor according to claim 1 on upper and lower surfaces of the coil layer;
(c) pressing and curing the coil layer and the metal-polymer complex films for an inductor;
(d) dicing the resultant structure subjected to Stage (c) to thereby separate the plurality of coil parts into each single coil part; and
(e) forming external electrodes on the resultant structure subjected to Stage (d).

18. The method according to claim 17, further comprising, between Stage (a) and Stage (b), performing a punching process to provide core holes penetrating the coil layer, for the plurality of coil parts, respectively.

19. The method according to claim 17, wherein Stage (c) is performed under the conditions of a temperature of 170˜200° C., a surface pressure of 0.05˜20 kgf, and a vacuum degree of 0.1 torr or lower.
